(19) United States
(12) Patent Application Publication
(10) Pub. No.: US 2026/0023980 A1
(43) Pub. Date: Jan. 22, 2026

(54) REINFORCEMENT LEARNING WITH LARGE LANGUAGE MODEL FEEDBACK

(71) Applicant: Palo Alto Networks, Inc., Santa Clara, CA (US)

(72) Inventors: Bin Wang, Sunnyvale, CA (US); Insiya Farhan Gunja, Cupertino, CA (US)

(21) Appl. No.: 18/777,144

(22) Filed: Jul. 18, 2024

(51) Int. Cl. G06N 3/092

(52) U.S. Cl. CPC G06N 3/092

(57) ABSTRACT

Query data and response data of a prompt to a target machine learning large-language-model are received. At least a portion of the response data of the target machine learning large-language-model is provided in a prompt to a judge machine learning large-language-model to determine a hallucination metric associated with a hallucination of the target machine learning large-language-model. Reinforcement learning of the target machine learning large-language-model is performed using at least the hallucination metric.

### BACKGROUND OF THE INVENTION

Large language models are large machine learning neural networks capable of generating content. They occasionally generate factually incorrect or misleading text known as hallucinations. These hallucinations can be resolved using reinforced learning from human feedback. In reinforced learning from human feedback, human annotators grade batches of responses generated from the large language model. Given the large amount of human feedback needed to improve a model through human feedback, it is time consuming and costly to always use human annotators in reinforcement learning.

### BRIEF DESCRIPTION OF THE DRA WINGS

Various embodiments of the invention are disclosed in the following detailed description and the accompanying drawings.

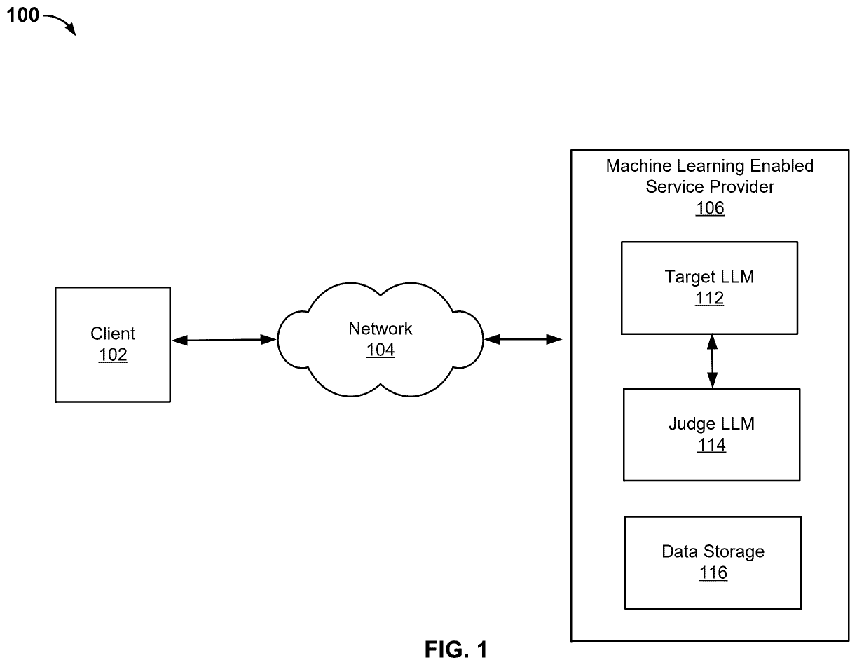

FIG. 1 is a block diagram illustrating an embodiment of a system for reinforcement learning of a target large language model (LLM) with large language model feedback.

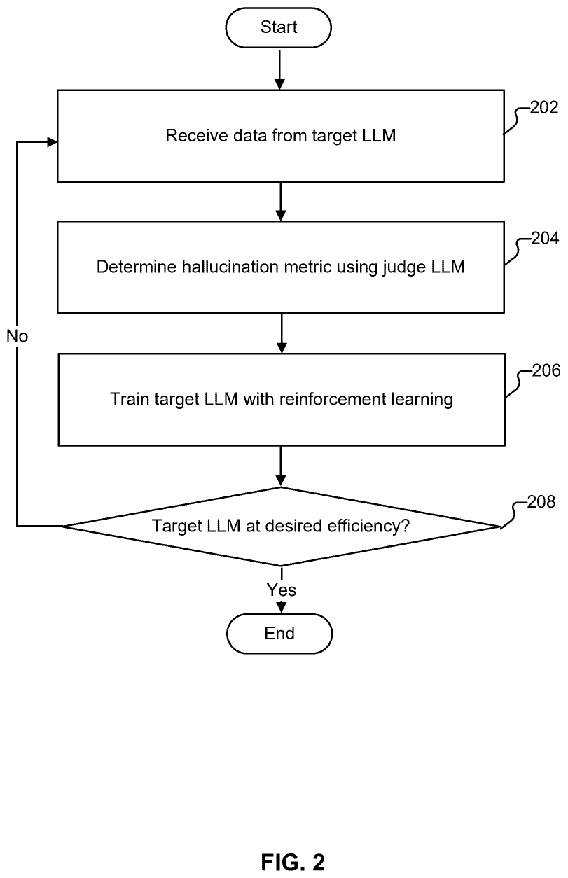

FIG. 2 is a flow diagram illustrating an embodiment of a process for reinforcement learning of a target LLM with feedback from a judge LLM.

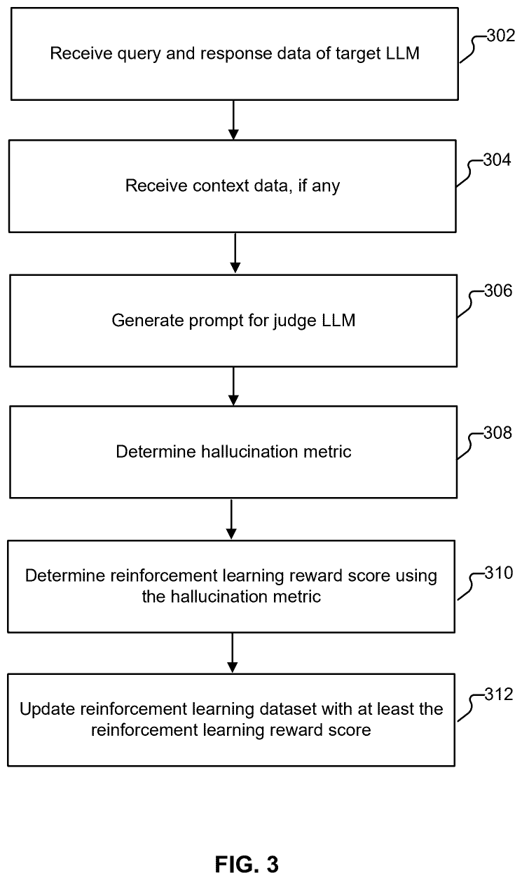

FIG. 3 is a flow diagram illustrating an embodiment of a process for creating a reinforcement learning dataset based on data from a target LLM and output from a judge LLM.

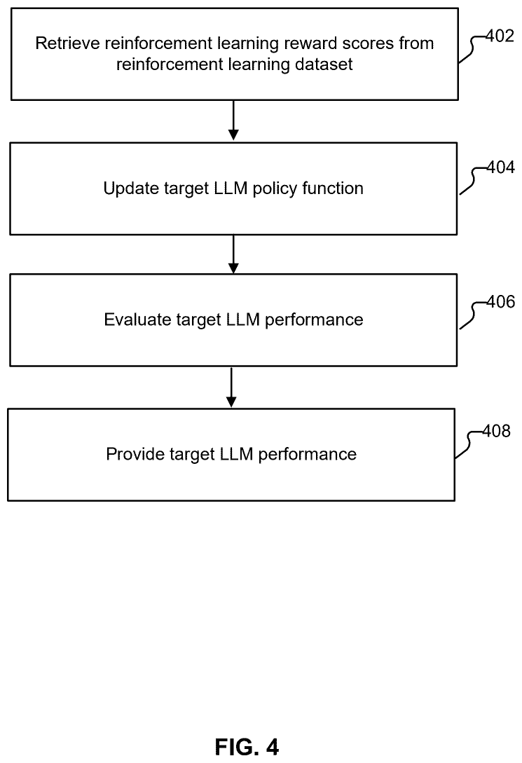

FIG. 4 is a flow diagram illustrating an embodiment of a process for reinforcement learning training of a target LLM.

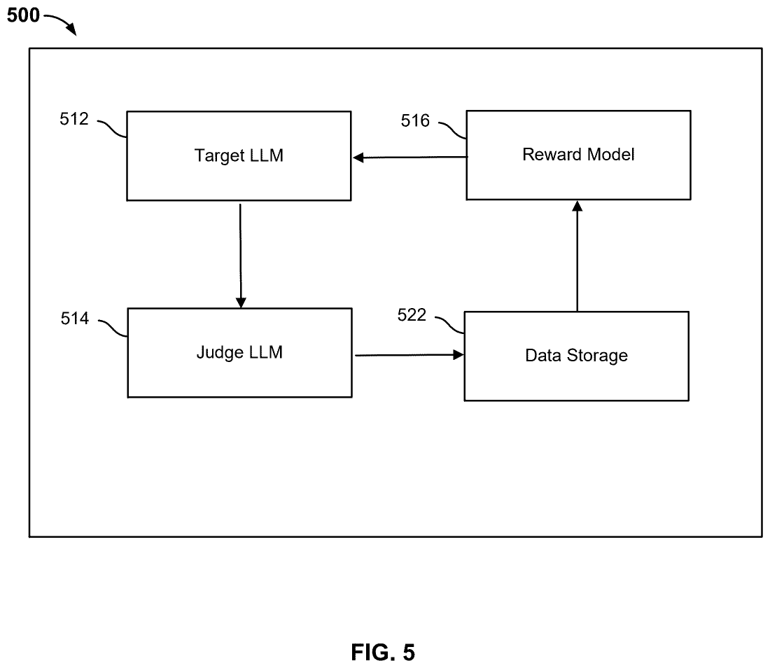

FIG. 5 is a block diagram illustrating an embodiment of a machine learning LLM system for training a target LLM using reinforcement learning with feedback from a judge LLM.

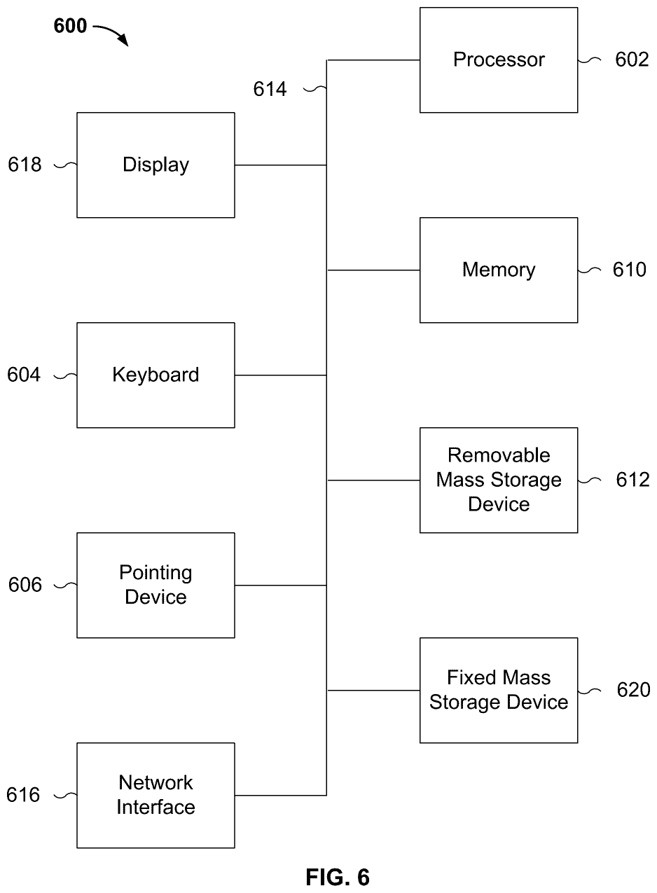

FIG. 6 is a functional diagram illustrating a programmed computer system for performing reinforced learning with LLM feedback.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Reinforcement learning with large language model feedback is disclosed. Rather than solely relying on human annotations to generate data for reinforcement learning, data used for reinforcement learning is automatically generated using a machine learning model. For example, a judge large language model (LLM) is prompted to determine a metric based on a result of a target LLM. The metric is used in various embodiments, and using the hallucination metric, a reward score is determined as part of the reinforcement learning dataset. The reinforcement learning dataset is used to improve the performance of the target LLM through reinforcement learning using the reward score. The user may perform multiple rounds of reinforcement learning training, each requiring batches of reinforcement learning reward scores generated by the judge LLM, to improve the target LLM to reach its desired performance. Thus by using automatically generated metric data of a judge LLM rather than a human reviewer, training and improvement of the target LLM are performed in a more efficient manner.

In some embodiments, query data and response data of a prompt to a target machine learning language model (LLM) is received. For example, a user prompts a target LLM to summarize content, and the user's prompt, content to be summarized, and generated summary from the target LLM are received. In some embodiments, the content to be summarized includes ticket data and associated comments. For example, a support or incident ticket for a security event along with associated user and/or administrator comments are to be summarized. In some embodiments, at least a portion of the response data of the target LLM is provided in a prompt to a judge machine learning large-language-model to determine a hallucination metric associated with a hallucination of the target machine learning large-language-model. For example, the judge LLM is given the query and response data of the target LLM and the content to be summarized, and the judge LLM determines the hallucination metric based on the number of instances the response data of the target LLM contains information not included in the content to be summarized. The hallucination metric may be associated with the numerical amount of information in the target LLM response summary that is not present in the content to be summarized. In some embodiments, reinforcement learning of the target machine learning large-language-model using at least the hallucination metric is performed. For example, the hallucination metric is used to create reinforcement learning training data that is applied to the target LLM. The reinforcement learning training data is used for reinforcement learning to improve the target LLM. In various embodiments, using the hallucination metric, a reward score is determined as part of the reinforcement learning dataset. The reinforcement learning dataset is used to improve the performance of the target LLM through reinforcement learning using the reward score. The user may perform multiple rounds of reinforcement learning training, each requiring batches of reinforcement learning reward scores generated by the judge LLM, to improve the target LLM to reach its desired performance.

FIG. 1 is a block diagram illustrating an embodiment of a system for reinforcement learning of a target large language model (LLM) with large language model feedback. In the example shown, system 100 includes client 102, network 104, and machine learning enabled service provider 106. Machine learning enabled service provider 106 includes target LLM 112 and judge LLM 114. In some embodiments, target LLM 112 and judge LLM 114 are different LLMs. In some embodiments, target LLM 112 and judge LLM 114 are the same LLM. In some embodiments, target LLM 112 and/or judge LLM 114 are local to machine learning enabled service provider 106. In some embodiments, target LLM 112 and/or judge LLM 114 are external to machine learning enabled service provider 106 and provided as a third-party service to machine learning enabled service provider 106 that can be tuned and further trained and refined. In various embodiments, client 102 includes one or more computers or other hardware components that provide prompts comprising of a formed request for a service to be provided by machine learning enabled service provider 106. Examples of a prompt include a request to summarize ticket data and associated comments and a request to build a hypertext transfer protocol request (http) based on a schema and query provided. In various embodiments, client 102 possesses text generation prompts to be sent to the machine learning enabled service provider for processing. In the example illustrated, client 102 is communicatively connected to machine learning enabled service provider 106 via network 104. Prompts are transmitted from client 102 to and responses received from machine learning enabled service provider 106 using network 104. Examples of network 104 include one or more of the following: a direct or indirect physical communication connection, internet, intranet, Local Area Network, Wide Area Network, Storage Area Network, and any other form of connecting two or more systems, components, or storage devices together. In various embodiments, machine learning enabled service provider 106 includes one or more processors or other enabled hardware components that are utilized to provide a service for client 102. For example, in some embodiments, machine learning enabled service provider 106 utilizes context data and a schema provided by client 102 to generate a text output associated with the context data and returns the result to client 102.

In various embodiments, machine learning enabled service provider 106 includes one or more servers, processors, or other hardware components that are utilized to execute/utilize target LLM 112 and judge LLM 114. The target LLM 112 and judge LLM 114 interact with each other to improve the service provided by the machine learning enabled service provider 106. For example, target LLM 112 may hallucinate when generating a response to the prompt provided by client 102 and received by machine learning enabled service provider 106. The hallucination could result in machine learning enabled service provider 106 providing client 102 with a response that is misleading or factually incorrect. Judge LLM 114 can be used to improve the performance of target LLM 112 through feedback generated by judge LLM 114. As described in further detail herein, the techniques disclosed herein more efficiently solve the hallucination problem for scenarios in which machine learning enabled service provider 106 provides an LLM based service through target LLM 112. For example, output of target LLM 112 is evaluated using judge LLM 114, and the output of judge LLM 114 is used to automatically generate reinforcement learning training data stored in data storage 116. This reinforcement learning training data stored in data storage 116 can be used during reinforcement learning of target LLM 112 to reduce its hallucinations.

FIG. 2 is a flow diagram illustrating an embodiment of a process for reinforcement learning of a target LLM with feedback from a judge LLM. In some embodiments, at least a portion of the process of FIG. 2 is performed by machine learning enabled service provider 106 of FIG. 1. In some embodiments, the judge LLM is the same model as the target LLM. For example, the judge LLM hyperparameters and parameters are the exact same as the target LLM. In some embodiments, the judge LLM is a different model from the target LLM. In some embodiments, reinforcement learning is implemented on one or more processors.

At 202, data from the target LLM is received by the judge LLM. Examples of data transfer between the target LLM and the judge LLM may use one or more of the following: file transfer protocol, universal serial bus, internet, cloud services, shared storage devices, or any other forms of transferring data. In some embodiments, the data received by the judge LLM includes query and response data from the prompt given to the target LLM. Query data may include any files and/or text used as input to the target LLM. In some embodiments, the query data may include context data for the target LLM prompt. The context data may be represented as text typed into the prompt and/or one or more additional files embedded into the prompt for the target LLM. In some embodiments, the context data contains content to be summarized by the target LLM. In some embodiments, the context data provides a schema for the generated output of the target LLM. Response data for a given prompt includes any files and/or text generated by the target LLM in response to the prompt.

At 204 the hallucination metric is determined using the judge LLM. In some embodiments, the judge LLM is prompted to provide the hallucination metric based on the query and response data received from the target LLM. In some embodiments, the hallucination metric is based on the quantity of information contained in the target LLM response data but not in the target LLM query or context data. For example, the judge LLM is prompted to provide an amount of information in the response of the target LLM but not mentioned in the corresponding LLM query and/or context data of the corresponding LLM query. In some embodiments, the hallucination metric is a scalar value representing the quantity of information contained in the target LLM response data but not in the target LLM query or context data. In some embodiments, the hallucination metric is a word or phrase describing the quantity of information contained in the target LLM response data but not in the target LLM query or context data. In some embodiments, the hallucination metric is a word, phrase, number, or scalar value associated with the severity of the hallucinations in the target LLM response data.

At 206, the target LLM is trained with reinforcement learning. In some embodiments, the reinforcement learning of the target LLM is based on scalar reward values associated with the hallucination metrics determined by the judge LLM. In some embodiments, a copy of the target LLM is trained with reinforcement learning. The copy of the target LLM has the same parameters as the initial target LLM. In some embodiments, during reinforcement learning, some of the parameters of the target LLM are frozen so that the main body of the target LLM is maintained and only the necessary parameters are fine tuned. For example, a copy of the target LLM is fine-tuned using reinforcement learning and can replace the initial target LLM.

At 208, it is determined whether the target LLM has reached a desired efficiency. For example, the target LLM has reached the desired efficiency when an efficiency metric of the target LLM meets a threshold value, and the target LLM has not reached the desired efficiency when the efficiency metric of the target LLM does not meet the threshold value. In some embodiments, the efficiency metric is based on one or more the following: target LLM hallucinations, accuracy and/or loss of a target LLM testing split, and/or loss function output. If at 208 it is determined that the target LLM has reached the desired efficiency, then reinforcement learning training of the target LLM is concluded. If at 208 it is determined that the target LLM has not reached the desired efficiency, then the process of FIG. 2 is repeated to further perform reinforcement learning training data generation and reinforcement learning training of the target LLM.

FIG. 3 is a flow diagram illustrating an embodiment of a process for creating a reinforcement learning dataset based on data from a target LLM and output from a judge LLM. In some embodiments the target LLM and judge LLM are the same LLM. In some embodiments, the judge LLM is a different LLM than the target LLM. In some embodiments, the process of FIG. 3 is performed by machine learning enabled service provider 106 of FIG. 1. In some embodiments, at least a portion of the process of FIG. 3 is included in 204 of FIG. 2.

At 302, query and response data of the target LLM is received. Query data includes any files and/or text used as an input query to the target LLM. For example, the query data consists of at least the prompt given to the target LLM. The response data includes at least the output generated by the target LLM. The output may be in the form of text and/or files. In some embodiments, the query data of the target LLM includes a request to summarize content, and the response data includes the requested summary generated by the target LLM. For example, content of an incident ticket in a computer security incident tracking system is provided or referenced in a query to summarize the ticket with description, root cause, and solution, and the response data of the target LLM includes the summary of the ticket's description, root cause, and solution. There is a chance that the target LLM hallucinates if the target LLM generated a summary that includes information not present in the content to be summarized. In some embodiments, the received query data of the target LLM includes a request to generate a formed request for desired service that should follow a schema, and the response data includes the target LLM generated request. For example, the query to the target LLM is a request to generate a well-formed http request to be provided to a computer network firewall device to request network activity alert data. The http request to be generated is to follow a schema and includes one or more parameters that specify the requested information. There is a chance that the target LLM hallucinates if the target LLM generated a request that includes parameters not present in the schema.

At 304, context data, if any, is received. The context data includes additional information that is used by the target LLM to generate its response. For example, other information not directly present in the received query data but utilized to generate the data included in the received response data is received. In a specific example, the context data includes linked content to be summarized by the target LLM. As another example, the context data includes a schema to be followed for a service request or code to be generated as the output of the target LLM. The received target LLM query data may reference (e.g., link or address/identifier of context data included in the query) and/or imply context data (e.g., schema to be followed implied in the nature of the query) to be used to generate the target LLM response, and the context data is retried. In some embodiments, the context data is associated with retrieval augmented generation. For example, when the target LLM query was executed, context data relevant to the target LLM query was searched and retrieved from a data repository and provided to the target LLM to generate the target LLM response. This same context data is obtained and/or retrieved in 304.

At 306, a prompt for the judge LLM is automatically generated. Based on at least a portion of the received query and response data of the target LLM and the context data, if any, the prompt for the judge LLM is automatically generated. In some embodiments, the judge LLM prompt includes a request to evaluate the response data of the target LLM with respect to the query data and context data of the target LLM. For example, the prompt requests the judge LLM to identify a quantity of parameters included in a formed http service response data but not in the query data and context data (e.g., a schema for the formed http service request). In another example, the prompt requests the judge LLM to identify a quantity of information found in a response data including a summary but not in the query data and context data including computer security incident ticket information. A specific example of the automatically generated judge LLM prompt is the following:

```
Given the following ticket conversation and its summarization, is there
any information that is found in the summary but not in the original
ticket conversation?
The ticket conversation is: {
  Adelphi QA: GPCS: Not able to access adelphi UI after master
  build #214
  !image-2019-09-17-17-11-25-922.png|thumbnail!
  Setup details:
  Environment details:
  Project: ngfw-demo
  cluster: paas-1
  tenant id:6056810461696285611
  logging tenant-id:1921124953
  support acct id: 31237
  custid: 2560
  Access to UI:
  https://ngfw-demo.firebaseapp.com/?tenantId=6056810461696285611
  !screenshot-1.png|thumbnail!
}
The summary is: {The Adelphi UI is inaccessible after the master
build #214. The issue is observed in the ngfw-demo project, paas-1
cluster. A workaround is to use an incognito/private browser window
to access the UI.}
The number of pieces of information that is found in summary but not in
the original conversation is?
```

At 308, a hallucination metric is determined based on a response to the judge LLM prompt. The judge LLM prompt generated in 306 is provided to the judge LLM and a response to the judge LLM prompt is used to determine the hallucination metric. For example, a number value output in the response is the hallucination metric. In some embodiments, the hallucination metric is associated with a quantity of information that is found in the response data of the prompt to the target machine learning large-language-model but not in context data associated with the query data. For example, the hallucination metric is a scalar value equal to the number of keywords in the response but not in the context or query data. Keywords may exclude one or more of the following: articles, prepositions, conjunctions, pronouns, auxiliary verbs, and adverbs. In some embodiments, the hallucination metric is associated with the number of fields included in the response data of the target LLM but not included in a schema provided in the context data. The number of fields not included in the schema may be represented by a scalar value. In some embodiments, the hallucination metric is associated with a quantity of information that is found in the response data of the prompt to the target machine learning large-language-model but not in context data associated with the query data. The hallucination metric may be an integer, a decimal number, or a fraction associated with the number of hallucinations per word, sentence, or any grouping of words.

At 310, a reinforcement learning reward score is determined using the hallucination metric. In some embodiments, the reinforcement learning reward score is a scalar value associated with the hallucination metric. For example, the reinforcement learning reward score is a positive or negative scalar value. As another example, the reinforcement learning reward score is a value between 0 and 1. In some embodiments, the reinforcement learning reward score is the logarithm of the hallucination metric. In some embodiments, the reinforcement learning reward score is determined using a mathematical function with an output between an upper and lower bound. For example, the mathematical function exhibits exponential growth so that as the hallucination metric increases, the output of the function approaches the upper bound but for low hallucination metric values, the output of the function maintains values close to the lower bound. As another example, the mathematical function exhibits decay so that as the hallucination metric increases, the output of the function rapidly decreases and approaches a lower bound while low hallucination metric values are close to the upper bound.

At 312, a reinforcement learning dataset is updated with at least the reinforcement learning reward score. In some embodiments, the reinforcement learning scores are paired with the query/context and/or response data of the target LLM to create the reinforcement learning dataset. In some embodiments, the reinforcement learning scores, query/context data of the target LLM, and response data of the target LLM are joined together to create the reinforcement learning dataset. The reinforcement learning dataset may be stored in one or more of the following: text files, binary files, databases, cloud storages, RAM, in-memory databases, distributed storages, external storage devices, or any other form of storing data.

FIG. 4 is a flow diagram illustrating an embodiment of a process for reinforcement learning training of a target LLM. The target LLM is fine-tuned through reinforcement learning training based on reinforced learning reward scores from a reinforced learning dataset. In some embodiments, the process of FIG. 4 is performed by machine learning enabled service provider 106 of FIG. 1. In some embodiments, at least a portion of the process of FIG. 4 is performed in 206 of FIG. 2.

At 402, reinforcement learning reward scores are retrieved from the reinforcement learning dataset. In various embodiments, the reinforcement learning dataset includes query, context, and/or response data associated with the reinforcement learning reward scores. In some embodiments, the reinforcement learning dataset is split into a training and testing dataset. For example, 80% of the reinforcement learning dataset becomes the training dataset and 20% of the reinforcement learning dataset becomes the testing dataset.

At 404, the target LLM policy function is updated using the reinforcement learning reward scores. The target LLM adjusts its policy function based on the reinforced learning reward scores. In some embodiments, the reinforcement learning reward scores are positive and negative scalar values, and how the policy function is modified is associated with the signs of the reinforcement learning reward scores. For example, for a particular query/context and response, a positive reinforced learning reward score modifies the policy function so that the likelihood of that particular response is higher. As another example, for a particular query/context and response, a negative reinforcement learning reward score modifies the policy function so that the likelihood of that particular response is lower. In some embodiments, the reinforcement learning reward scores are between an upper bound value and lower bound value, and the adjustment of the policy function is associated with how close the reinforcement learning reward scores are to the upper and lower bounds.

At 406, the target LLM performance is evaluated. In some embodiments, the target LLM performance is determined by using a testing dataset derived from the reinforcement learning dataset. The testing dataset may include query and response data and hallucination metrics from previous prompts given to the target LLM but not used during reinforcement learning of the target LLM. In some embodiments, performance is measured by feeding the updated target LLM with previous prompts, determining the hallucination metric of the generated response from the target LLM by using the judge LLM, and evaluating the difference between the old hallucination metric and new hallucination metric. The target LLM performance is associated with the difference between the old hallucination metric and the new hallucination metric given the same prompt to the target LLM. In some embodiments, the target LLM performance is associated with a scalar value. In some embodiments, the scalar value is determined through a loss function.

At 408, the target LLM performance is provided. In some embodiments, the target LLM performance is provided after a single round of training. For example, the target LLM is trained on the whole reinforcement learning dataset and the target LLM performance is provided. In some embodiments, the target LLM performance is provided after multiple rounds of training. For example, the target LLM is trained on multiple instances of the reinforcement learning dataset before outputting its performance. In some embodiments, the target LLM performance is output on a display. The display may be a component in client 102 of FIG. 1, network 104 of FIG. 1, machine learning enabled service provider 106 of FIG. 1, or any combination of client 102 of FIG. 1, network 104 of FIG. 1, and machine learning enabled service provider 106 of FIG. 1.

FIG. 5 is a block diagram illustrating an embodiment of a machine learning LLM system for training a target LLM using reinforcement learning with feedback from a judge LLM. Machine learning LLM system 500 includes different components that may be used together to train a target LLM using reinforcement learning with feedback from a judge LLM. In some embodiments, machine learning LLM system 500 is included in Machine Learning Enabled Service Provider 106 of FIG. 1. In the example shown, machine learning LLM system 500 includes target LLM 512, judge LLM 514, data storage 522, and reward model 516. In various embodiments, the different components are communicatively connected. For example, query and response data from target LLM 512 are fed to judge LLM 514. In some embodiments, the generated output of judge LLM 514 is fed to data storage 522. In some embodiments, the output of judge LLM 514 is fed directly to the reward model. In some embodiments, reward model 516 retrieves data from data storage 522. Reward model 516 uses the generated output of judge LLM 514 to fine tune target LLM 512 through reinforcement learning.

In some embodiments, target LLM 512, which includes various subsystems as described below, includes at least one processor. For example, target LLM 512 may be implemented by a singular processing unit or by multiple processing units. In some embodiments, the target LLM 512 is run on one or more graphic processing units. In some embodiments, the target LLM 512 is implemented by specialized hardware or a computer system designed for machine learning tasks. For example, target LLM 512 is implemented by hardware accelerators, AI computing platforms, AI frameworks, ML compilers, cloud services, or any combination of machine learning accelerators.

In some embodiments, judge LLM 514, which includes various subsystems as described below, includes at least one processor. For example, judge LLM 514 may be implemented by a singular processing unit or by multiple processing units. In some embodiments, judge LLM 514 is executed on one or more graphic processing units. In some embodiments, judge LLM 514 is implemented by specialized hardware or a computer system designed for machine learning tasks. For example, judge LLM 514 is implemented by hardware accelerators, AI computing platforms, AI frameworks, ML compilers, cloud services, or any combination of machine learning accelerators. In some embodiments, judge LLM 514 is implemented by the same processor or processors as target LLM 512.

In some embodiments, data storage 522 is a storage system capable of at least storing the output of judge LLM 514 and is coupled either bi-directionally (read/write) or unidirectionally (read only) to judge LLM 514. In some embodiments, data storage 522 is coupled to reward model 516 and/or target LLM 512. Data storage 522 may also store any additional data from target LLM 512. In some embodiments, a computer system is used to implement data storage 522. For example, data is stored on the first and/or primary storage areas of the computer system. In some embodiments, the computer system used to implement data storage 522 is the same computer system used to implement judge LLM 514. For example, random-access memory or read-only memory of data storage 522 of the computer system is used to implement judge LLM 514. In some embodiments, data storage 522 is implemented by a storage system including one or more of the following: text files, binary files, databases, cloud storages, in-memory databases, distributed storages, external storage devices, or any other form of storing data.

In some embodiments, reward model 516 is a program or system capable of performing reinforcement learning on target LLM 512. Reward model 516 is coupled with a storage system with reading functionality and/or read/write functionality. For example, reward model 516 can retrieve and read data from data storage 522. In some embodiments, reward model 516 is implemented by lines of code that reference data from data storage 522. The code may be executed by or within one or more of the following: interactive interpreter, script, interactive development environment, or cloud-based execution.

FIG. 6 is a functional diagram illustrating a programmed computer system for performing reinforced learning with LLM feedback. As will be apparent, other computer system architectures and configurations can be utilized for performing reinforcement learning with LLM feedback. Examples of computer system 600 include client 102 of FIG. 1, one or more computers used to implement target LLM 112 of FIG. 1 and/or target LLM 512 of FIG. 5, one or more computers used to implement judge LLM 114 of FIG. 1 and/or judge LLM 514 of FIG. 5, one or more computers used to implement reward model 516 of FIG. 5, and/or one or more computers used to implement data storage 522 of FIG. 5. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618). In various embodiments, one or more instances of computer system 600 can be used to implement at least portions of the processes of FIGS. 2 through 4.

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data and objects used by the processor 602 to perform its functions (e.g., programmed instructions). For example, memory 610 can include any suitable computer-readable storage media, described below, depending on whether, for example, data access needs to be bi-directional or unidirectional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or unidirectionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storages 612, 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving query data and response data of a prompt to a target machine learning large-language-model;
providing at least a portion of the response data of the target machine learning large-language-model in a prompt to a judge machine learning large-language-model to determine a hallucination metric associated with a hallucination of the target machine learning large-language-model; and
performing reinforcement learning of the target machine learning large-language-model using at least the hallucination metric.

2. The method of claim 1, wherein the target machine learning large-language-model and the judge machine learning large-language-model are the same model.

3. The method of claim 1, wherein the target machine learning large-language-model and the judge machine learning large-language-model are different models trained using different data.

4. The method of claim 1, further comprising receiving context data associated with the prompt to the target machine learning large-language-model.

5. The method of claim 4, wherein the context data includes a schema for the response data.

6. The method of claim 5, wherein the prompt to the target machine learning large-language-model is associated with generating a formed request to a service.

7. The method of claim 6, wherein the hallucination metric is associated with a number of fields included in the response data of the target machine learning large-language-model but not included in the schema.

8. The method of claim 4, wherein the context data is associated with retrieval augmented generation.

9. The method of claim 4, wherein the prompt to the judge machine learning large-language-model includes or references the received context data.

10. The method of claim 1, wherein the prompt to the target machine learning large-language-model is associated with summarizing content.

11. The method of claim 10, wherein the content to be summarized includes ticket data and associated comments.

12. The method of claim 10, wherein the hallucination metric is associated with a numerical amount of information included in a summary included in the response data of the target machine learning large-language-model but not included in the content to be summarized.

13. The method of claim 1, wherein the prompt to the judge machine learning large-language-model includes a request for the hallucination metric.

14. The method of claim 1, wherein the hallucination metric is associated with a quantity of information that is found in the response data of the prompt to the target machine learning large-language-model but not in context data associated with the query data.

15. The method of claim 1, wherein performing the reinforcement learning of the target machine learning large-language-model using at least the hallucination metric includes determining a reinforcement learning reward score based on the hallucination metric.

16. The method of claim 15, wherein the reinforcement learning reward score is based on a logarithm of the hallucination metric.

17. A system, comprising:
one or more processors configured to:
receive query data and response data of a prompt to a target machine learning large-language-model;
provide at least a portion of the response data of the target machine learning large-language-model in a prompt to a judge machine learning large-language-model to determine a hallucination metric associated with a hallucination of the target machine learning large-language-model; and
perform reinforcement learning of the target machine learning large-language-model using at least the hallucination metric; and
a memory coupled to at least one of the one or more processors and configured to provide the at least one of the one or more processors with instructions.

18. The system of claim 17, wherein the target machine learning large-language-model and the judge machine learning large-language-model are the same model.

19. The system of claim 17, wherein the hallucination metric is associated with a quantity of information that is found in the response data of the prompt to the target machine learning large-language-model but not in context data associated with the query data.

20. A computer program product, the computer program product being embodied in a non-transitory computer readable storage medium and comprising computer instructions for:
receiving query data and response data of a prompt to a target machine learning large-language-model;
providing at least a portion of the response data of the target machine learning large-language-model in a prompt to a judge machine learning large-language-model to determine a hallucination metric associated with a hallucination of the target machine learning large-language-model; and
performing reinforcement learning of the target machine learning large-language-model using at least the hallucination metric.
